(19) United States
(12) Patent Application Publication
(10) Pub. No.: US 2025/0390369 A1
(43) Pub. Date: Dec. 25, 2025

(54) METHOD FOR UNBOLTING AN ACCESS SYSTEM USING A MOBILE DEVICE AND/OR FOR ERROR DETECTION, RELATING TO AN UNBOLTING OF AN ACCESS SYSTEM; READING DEVICE; SYSTEM; COMPUTER PROGRAM PRODUCT

(71) Applicant: DORMAKABA SCHWEIZ AG, Rümlang (CH)

(72) Inventor: Christian RAPPEL, Rümlang (CH)

(21) Appl. No.: 18/866,321

(22) PCT Filed: May 9, 2023
(86) PCT No.: PCT/EP2023/062301

§ 371 Date: Sep. 8, 2025

(30) Foreign Application Priority Data
May 18, 2022 (EP) 22174177.0

(51) Int. Cl. G06F 11/07; G06F 8/65; G07C 9/00

(52) U.S. Cl. CPC G06F 11/0757; G06F 8/65; G06F 11/0742; G07C 9/00309

(57) ABSTRACT

A method for unbolting an access system using a mobile device and/or for error detection is provided, relating to an unbolting of an access system,
with the access system having a reading device with a communication interface for receiving communication signals from the mobile device, with the method including the following steps:
   a) Receiving a first communication signal, relating to an unbolting of the access system by way of the reading device from the mobile device at a first point in time,
   b) making an unbolting decision for the access system—at a second point in time after the first point in time—by way of the reading device,
wherein a first time duration is determined and/or measured as a function of the first point in time and the second point in time, and
   c) performing an error detection as a function of the first time duration.

### CROSS-REFERENCE TO RELATED APPLICATIONS

This application is a 35 U.S.C. § 371 National Stage patent application of PCT/EP2023/062301, filed on 9 May 2023, which claims the benefit of European patent application 22174177.0, filed on 18 May 2022, the disclosures of which are incorporated herein by reference in their entirety.

### TECHNICAL FIELD

The present disclosure relates to a method for unbolting an access system using a mobile device and/or for error detection, relating to an unbolting of an access system. The disclosure also relates to a reading device, a system and a computer program product.

### BACKGROUND

Access systems, in particular door systems, are used in or on buildings or areas to control or restrict access to certain areas and rooms and to separate individual areas and rooms from the rest of the building or area. A number of access systems have lock mechanisms that can only be unlocked by authorised persons. Mechanical keys are increasingly being replaced by electronic key systems in which a reading device of the access system receives authorisation information and unbolts or opens the access system as a result.

In practice, various communication technologies, in particular wireless technologies, can be used to communicate between a mobile device of a user and the reading device of the access system to unbolt an access system. In practice, technical problems can occur during communication between the mobile device and the reading device or software problems on the part of the mobile device or the reading device that prevent the access system from unlocking smoothly. Particularly with frequently used access systems, this can lead to considerable problems and delays or completely prevent an authorised person from entering a room or building.

EP 1 408 458 A2 discloses a remote control system for vehicles with a portable transmitting and receiving device and a transmitting and receiving device on the vehicle. The transmitting and receiving devices each have two transmitters and two receivers to ensure the functionality of the transmitting and receiving devices if one transmitter and/or receiver fails.

US2022/068061A1 relates to a method for operating an access control device, with an unlocking signal being sent to the access control device after successful comparison of a transmitted proof of authorisation with stored authorisation information.

### SUMMARY

Against this background, the disclosure provides an advantageous method for unbolting an access system using a mobile device and/or an advantageous method for error detection, relating to an unbolting of an access system, with which problems and errors during unbolting processes can be efficiently detected.

This is achieved by providing a method for unbolting an access system using a mobile device and/or for error detection, relating to an unbolting an access system,
with the access system having a reading device with a communication interface for receiving communication signals from the mobile device, with the method comprising the following steps:
   a) Receiving a first communication signal, relating to an unbolting of the access system by way of the reading device from the mobile device at a first point in time, with the first communication signal and/or an additional communication signal transmitted from the mobile device to the reading device comprising device type and/or software information of the mobile device,
   b) Making an unbolting decision for the access system—at a second point in time after the first point in time—by way of the reading device,
with a first time duration between the first point in time and the second point in time being determined and/or measured,
   c) Performing an error detection comprising a comparison of the first time duration with one or a plurality of threshold values, with it being determined whether errors or problems have occurred during unbolting as a function of the comparison and the device type and/or software information.

According to the disclosure, this allows problems or errors in the unbolting of the access system to be advantageously detected so that countermeasures can be taken to eliminate the errors. The first time duration can be used during error detection to determine whether the time delay between the requested or ordered unbolting using the first communication signal and the unbolting decision is unusually long. For example, it is conceivable that the error detection in step c) comprises a comparison of the first time duration with one or a plurality of threshold values, with it being determined whether errors or problems have occurred during unbolting as a function of the comparison. It is conceivable that, as part of the error detection in step c), it is determined that the unbolting decision was negative, i.e. the access system was not unbolted, and/or that the first time duration was unusually long, for example above a selectable threshold value, which may indicate an error or a problem, for example relating to the software of the mobile device or the reading device.

It is preferably conceivable that the steps of the method according to the disclosure are repeated for a number of unbolting attempts and/or for a number of different mobile devices. This is a particularly advantageous way of determining whether a certain access system and/or a certain reading device frequently exhibits problems or errors in practice. This may indicate, for example, that the reading device requires a software update or that there are other software or hardware problems, for example problems with the communication interface or with the activation of the lock of the access system. This allows targeted countermeasures, such as repair work, to be initiated.

The first communication signal is preferably an initial communication signal, relating to an unbolting of the access system by the mobile device. The first communication signal is preferably part of a first contact between the mobile device and the reading device, relating to an unbolting process of the access system. The first communication signal is preferably transmitted wirelessly.

The communication interface of the reading device for receiving communication signals from the mobile device is preferably a wireless communication interface.

Preferably, the reading device measures the first time duration in step b). It is particularly preferably conceivable that the first time duration is the time duration between the first point in time and the second point in time.

The error detection in step c) is preferably performed by an external server system, for example using a cloud. The server system has a communication connection with the access system and/or the mobile device for this purpose. It is conceivable that information indicating the first time duration is transmitted to the server system before step c) in order to perform the error detection. Alternatively, it is conceivable, for example, that the error detection in step c) is performed by the reading device. According to one embodiment of the present disclosure, error detection can also be understood as error recording and/or error analysis.

The access system is preferably a door system and/or a separating system. The access system is preferably part of a building and/or area. According to one embodiment of the present disclosure, it is conceivable that the access system is one of the following door systems and/or separating systems:
a rotating door,
a swing door,
a revolving door,
a security revolving door,
a personnel interlock,
a sliding door,
a folding sliding door,
a tripod turnstile,
a turnstile,
a pivot door.

The reading device can be a component of the access system or a device separate from the access system that communicates with the access system or with subcomponents of the access system. In particular, the reading device is configured to unbolt a lock, in particular an electric lock, of the access system. The reading device can have computer means of the access system or be designed as part of the computer means of the access system. The reading device can, for example, have parts of a control device of the access system or be in communicative connection with parts of a control device of the access system.

In particular, the method according to the disclosure is a computer-implemented method in which one, a plurality or all steps of the method are carried out in a computer-implemented manner.

Advantageous further developments and configurations of the present disclosure can be found in the dependent claims.

According to one embodiment of the present disclosure, it is provided that the first communication signal has authorisation information for unbolting the access system,
with the reading device checking the authorisation information before and/or as part of the unbolting decision,
preferably with the unbolting decision in step b) being made taking into account the authorisation information. The first communication signal is preferably a request or instruction for unbolting the access system by way of the mobile device. In particular, the unbolting decision is a decision as to whether or not the access system is unbolted. It is conceivable that the reading device initiates an unbolting of the lock of the access system as a result of the unbolting decision or as part of the unbolting decision if the check of the authorisation information shows that the checked authorisation information authorises the unbolting of the access system.

According to one embodiment of the present disclosure, it is provided that the first communication signal and/or an additional communication signal transmitted from the mobile device to the reading device has device type and/or software information of the mobile device,
with the device type and/or software information preferably having one of the following items of information:
   information indicating a device type of the mobile device; and/or
   information indicating a version and/or a type of a software application of the mobile device, with the software application being used by the mobile device to unbolt the access system; and/or
   information indicating a version and/or a type of an operating system of the mobile device. The device type and/or software information indicates in particular a software and/or hardware configuration of the mobile device. This makes it possible to establish a link between the software and/or hardware configuration of the mobile device and errors or problems during the unbolting process of the access system as part of the error detection. In particular, errors or problems caused by certain software and/or hardware of the mobile device, in particular in combination with the software and/or hardware of the reading device, can be identified as part of the error detection.

According to one embodiment of the present disclosure, it is provided that the device type and/or software information is anonymised, in particular in such manner that the device type and/or software information cannot be assigned to a certain person and/or a certain mobile device. This prevents information from being assigned to a certain user.

According to one embodiment of the present disclosure, it is provided that the error detection in step c) is additionally performed as a function of the device type and/or software information. This allows errors or problems with the unbolting of the access system to be identified and/or assigned to certain device types, software versions or operating system versions of the mobile device. It is conceivable, for example, that problems with the unbolting of the access system occur more frequently or exclusively for certain versions of a software application that use mobile devices to unbolt the access system, while other, for example more up-to-date, software application versions work without any problems. This enables improved error detection in step c). This allows problems to be identified in a targeted manner and appropriate countermeasures to be taken to rectify errors.

According to one embodiment of the present disclosure, it is provided that as part of the error detection in step c) it is determined,
whether there are errors and/or problems when unbolting the access system for:
   the device type of the mobile device; and/or
   the version and/or the type of the software application of the mobile device; and/or
   the version and/or the type of the operating system of the mobile device; and/or
   a version and/or a type of software of the reading device
and/or the access system. In particular, the software of the reading device can be a firmware of the reading device.

The determination that errors and/or problems are due to the version and/or the type of software of the reading device and/or the access system can be made, for example, by repeating the method according to the disclosure several times to determine that
certain types of mobile devices or
a number of mobile devices and/or a number of software application versions of mobile devices
   have systematic problems with unbolting the access system. This indicates that there is a malfunction of the reading device, which can be rectified in a targeted manner as a result of error detection of this type, for example by updating the software of the reading device, by replacing the faulty reading device or by carrying out repair work on site.

According to one embodiment of the present disclosure, it is provided that the method further comprises:
d) Determining—by way of the reading device—a number of further unbolting attempts and/or further first communication signals which the reading device receives, preferably from the mobile device, in a definable second time duration, starting with the first point in time,
   with the error detection in step c) being additionally performed taking into account the number of further unbolting attempts and/or further first communication signals received.

Step d) is preferably carried out before step c), such that the determined number of further unbolting attempts and/or further first communication signals is available during the error detection in step c). The length of the second time duration is preferably definable. For example, the second time duration can be five, seven or ten seconds from the first point in time. In particular, it is conceivable that the mobile device-in particular if the unbolting of the access system does not work as expected-transmits further first communication signals after the first communication signal, and in particular makes further unbolting attempts. Preferably, it is possible for such further first communication signals and/or further unbolting attempts to be counted within a selectable second time duration, which starts with the first point in time. The determined number of further unbolting attempts and/or further first communication signals received can be taken into account in an advantageous way when detecting the error. For example, receiving one or a plurality of further first communication signals by way of the reading device within the second time period indicates a problem or an error when unbolting the access system using the mobile device. The device type and/or software information can be used in a particularly advantageous way to track for which device type and/or which software application and/or which operating system of the mobile device and/or which version of the software of the reading device the problems have occurred.

According to one embodiment of the present disclosure, it is provided that the error detection in step c) comprises a determination of whether parts of the received first communication signal, in particular parts of the authorisation information, are incomplete or missing. This can be used to determine whether there are problems with the communication between the mobile device and the reading device in step a). This may indicate, for example, that the distance between the mobile device and the reading device in step a) was too great or that the communication interface of the reading device is faulty. However, if the method according to the disclosure is repeated for a number of mobile devices and/or unbolting attempts and parts of the first communication signals received are increasingly missing, this indicates with increased probability that the communication interface of the reading device is faulty.

According to one embodiment of the present disclosure, it is provided that the error detection in step c) is performed by a server system,
with information being transmitted to the server system before step c) which indicates:
   the first time duration, and
   optionally the device type and/or software information and
   optionally the number of further unbolting attempts and/or further first communication signals received.
      It is conceivable that this information is transmitted from the reading device to the server system. Alternatively, it is conceivable that this information is transmitted from the reading device to the mobile device and from the mobile device to the server system. The information can be transmitted using a telecommunications network, for example. Transmitting the information using the mobile device has the advantage of reducing the load on the reading device and its computing and communication capacities. The server system can be formed by one or a plurality of physical computers, for example using a cloud. In particular, the server system is an external server system that can be arranged at a different location to the access system.

According to one embodiment of the present disclosure, it is provided that, as a function of the error detection performed in step c):
the software application of the mobile device is changed and/or updated, with the software application being used by the mobile device to unbolt the access system; and/or
   the operating system of the mobile device is changed and/or updated; and/or
   the software of the reading device and/or the access system is changed and/or updated. These or other countermeasures can be carried out in response to the error detection to eliminate identified errors and/or problems.

According to one embodiment of the present disclosure, it is provided that a message is transmitted to the mobile device, in particular by the server system, as a function of the error detection carried out in step c),
with the message having information on an error and/or problem detected during the error detection in step c); or
with the message having a request or an instruction:
to change and/or update the software application of the mobile device, and/or
to change and/or update the operating system of the mobile device.
   The information, requests and/or instructions transmitted in this way by means of the message are configured for playback by the mobile device, for example by a screen of the mobile device, and can thus be communicated to a user of the mobile device.

According to one embodiment of the present disclosure, it is provided that the communication interface of the reading device is designed as an NFC (Near Field Communication) communication interface, a UWB (Ultra Wideband) communication interface or a BLE (Bluetooth Low Energy) communication interface, with the first communication signal preferably being an NFC communication signal, UWB communication signal or BLE communication signal.

Different technologies are therefore possible for the reading device or data transmission between a mobile device and the reading device for unbolting the access system.

According to one embodiment of the present disclosure, it is provided that a positioning message is transmitted to the mobile device as a function of the error detection in step c), with the positioning message having device type-dependent information and/or a request for positioning the mobile device relative to the reading device,
preferably with the device type-dependent information and/or request for positioning being communicated to a user via a playback device of the mobile device. This is particularly advantageous, for example, if communication between the mobile device and the reading device for unbolting the access system takes place via NFC. Different types of devices typically have different latencies when activating their NFC circuits. Furthermore, the NFC circuits are installed in different positions within a mobile device as a function of the device type, meaning that there are hardware-related differences for different device types. According to one embodiment, it is conceivable, for example, that the mobile device has an NFC circuit, in particular an RFID (radio-frequency identification) chip, for unbolting the access system, with a server system and/or the access system having access to position information, relating to a device type-dependent positioning of an NFC circuit within a mobile device, with the device type-dependent information and/or request transmitted to the mobile device for the user of the mobile device for positioning the mobile device relative to the reading device being dependent on the device type-dependent positioning of the NFC circuit within the mobile device. The user can thus be informed by the device type-dependent information and/or request how the user should align and/or arrange their mobile device (to unbolt the access system) relative to the reading device in order to successfully unbolt the access system. For example, in the event that the NFC circuit is arranged at the upper edge region of the mobile device, the user can be informed by the device type-dependent information and/or request that the user should position the upper edge region of the mobile device as close as possible to the reading device.

According to one embodiment of the present disclosure, it is conceivable that the reading device performs ranging, in particular UWB ranging, with the direction in which the mobile device is moving and/or how fast the mobile device is moving being recorded. It is conceivable that the data determined by ranging is used for the error detection.

A further advantage of the present disclosure is to provide a reading device for an access system, with the reading device having a communication interface for receiving communication signals from a mobile device,
with the reading device being configured to receive a first communication signal, relating to an unbolting the access system from the mobile device at a first point in time,
with the reading device being configured to make an unbolting decision—at a second point in time after the first point in time,
   with the reading device being configured to determine and/or measure a first time duration as a function of the first point in time and the second point in time. The reading device determines and/or measures the first time duration for performing an error detection as a function of the first time duration.

In particular, the reading device is configured to carry out a method according to an embodiment of the present disclosure, in particular to carry out steps a), b) and optionally d). Preferably, it is conceivable that the reading device is configured to transmit information indicating the determined and/or measured first time duration to a server system, with the error detection being performed by the server system. Alternatively, it is conceivable that the reading device is configured to carry out steps a), b), c) and optionally d).

Another advantage of the present disclosure is to provide a system, with the system comprising an access system with a reading device and a server system,
with the reading device having a communication interface for receiving communication signals from a mobile device,
   with the reading device being configured to receive a first communication signal, relating to an unbolting the access system from the mobile device at a first point in time,
   with the reading device being configured to make an unbolting decision—at a second point in time after the first point in time,
with the reading device being configured to determine and/or measure a first time duration as a function of the first point in time and the second point in time,
   with the server system being configured to perform an error detection as a function of the first time duration. In particular, the system is configured to carry out a method according to an embodiment of the present disclosure.

Another advantage of the present disclosure is to provide a computer program product comprising commands which, when executed by a computer system and/or a reading device and/or a server system, cause the latter to carry out a method according to an embodiment of the present disclosure.

The features, embodiments and advantages described in connection with one of the advantages according to the disclosure can also be applied to the other advantages according to the disclosure. In particular, the features, embodiments and advantages that have already been described in connection with the method according to the disclosure or in connection with an embodiment of the method according to the disclosure can be applied to the reading device according to the disclosure, the system according to the disclosure and the computer program product according to the disclosure.

### BRIEF DESCRIPTION OF THE DRAWINGS

Further advantages and details of the disclosure will be explained below on the basis of the exemplary embodiments represented in the drawings, which show

FIG. 1 a schematic representation of a system according to an exemplary embodiment of the present disclosure; and

FIGS. 2 to 4 schematic representations of methods according to exemplary embodiments of the present disclosure.

### DETAILED DESCRIPTION OF THE DRAWINGS

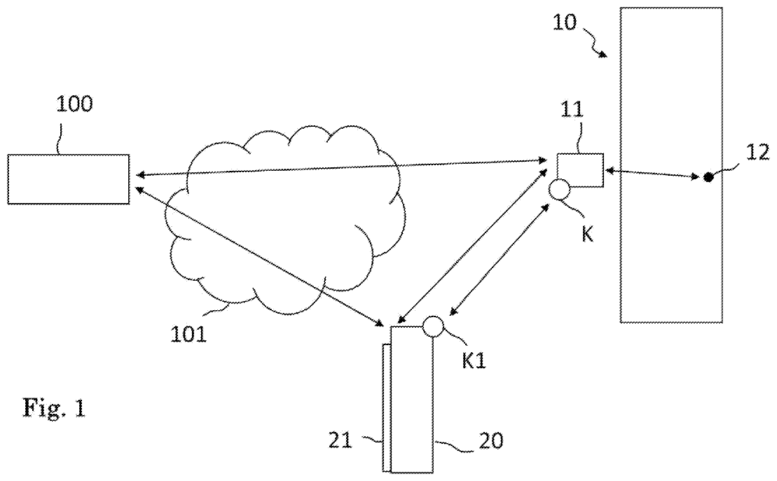

In FIG. 1, a schematic representation of a system according to an exemplary embodiment of the present disclosure is shown. An access system 10, in particular a door system, has a lock 12 with which a door element of the access system 10 can be locked and unbolted. The access system 10 is designed, for example, as part of a building or area. A reading device 11 is formed as part of the access system 10 or in the vicinity of the access system 10. The reading device 11 is configured to activate the lock 12 and is designed in such manner that it can unbolt the lock 12. The reading device 11 has a communication interface K, which is designed to receive communication signals from a mobile device 20. The communication interface K can be an NFC interface, a UWB interface or a BLE interface, for example. The mobile device has a corresponding communication interface K1. Signals for unbolting the lock 12 of the access system 10 can be transmitted from the mobile device 20 to the reading device 11 via the communication interfaces K and K1. The mobile device 20 is carried by a user. The mobile device 20 can be a smartphone or an electronic key device, for example. The mobile device 20 preferably has a playback device 21, for example a display. The playback device 21 can be used to communicate information to a user of the mobile device 20. The mobile device 20 and/or the reading device 11 can establish communication connections with a server system 100, for example a cloud system, via a communication network 101, for example a mobile phone network.

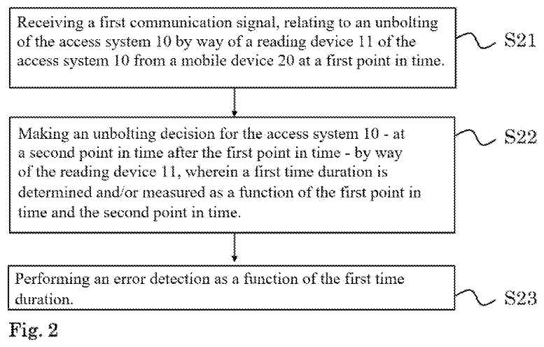

In FIG. 2, a schematic representation of a method for unbolting an access system 10 using a mobile device 20 and/or for error detection, relating to an unbolting of an access system 10, is shown according to an embodiment of the present disclosure. In a step S21, a first communication signal, relating to an unbolting of the access system 10 is received by a reading device 11 of the access system 10 from a mobile device 20 at a first point in time. In particular, the first communication signal is an initial communication signal that is transmitted by the mobile device 20 via its communication interface K1 and the communication interface K of the reading device 11 to unbolt the access system 10. In particular, the first communication signal comprises authorisation information that indicates authorisation to unbolt the access system 10. In S22, an unbolting decision is made for the access system 10—at a second point in time after the first point in time—by way of the reading device 11, with a first time duration being determined and/or measured as a function of the first point in time and the second point in time. Preferably, the first time duration is the time that elapses between the first and second points in time, i.e. in particular a latency between the unbolting request and the unbolting decision. In a step S23, an error detection is performed as a function of the first time duration. The length of the first time duration depends in particular on whether problems or errors have occurred during the unbolting of the access system 10 requested using the first communication signal. For example, it is conceivable that the error detection in step S23 comprises a comparison of the first time duration with one or a plurality of threshold values, with it being determined whether errors or problems have occurred during unbolting as a function of the comparison.

The error detection in step S23 is preferably performed by the server system 100. Before step S23, the server system receives information indicating the first time duration, for example from the reading device 11. Alternatively, it is conceivable, for example, that the error detection in S23 is performed by the reading device 11.

It is preferably conceivable that the steps of the method are repeated for a number of unbolting attempts and/or for a plurality of different mobile devices. In this way, it is particularly advantageous to determine whether recurring problems or errors occur for the access system 10 and/or the reading device 11. It can be concluded from recurring problems, relating to the same reading device 11, for example, that the reading device 11 requires a software update or that there are technical problems with the communication interface K or with the activation of the lock 12 of the access system 10. This allows targeted countermeasures, such as repair work, to be initiated.

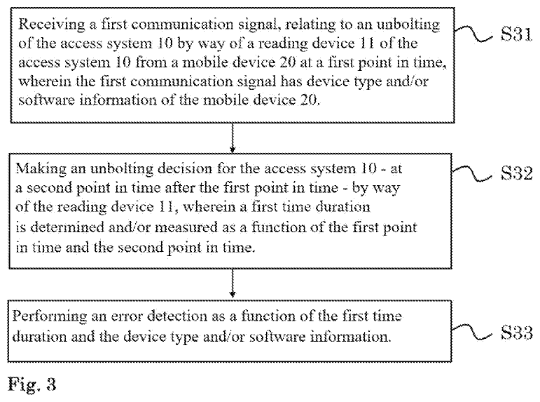

In FIG. 3, a schematic representation of a method for unbolting an access system 10 using a mobile device 20 and/or for error detection, relating to an unbolting of an access system 10, is shown according to an embodiment of the present disclosure. In a step S31, a first communication signal, relating to an unbolting of the access system 10 is received by a reading device 11 of the access system 10 from a mobile device 20 at a first point in time, with the first communication signal having device type and/or software information of the mobile device. The device type and/or software information preferably has one, a plurality or all of the following information in anonymised form:
information indicating a device type of the mobile device 20; and/or
information indicating a version and/or a type of a software application of the mobile device 20 used by the mobile device 20 to unbolt the access system 10; and/or
information indicating a version and/or a type of an operating system of the mobile device 20. In a step S32, an unbolting decision is made for the access system 10—at a second point in time after the first point in time—by way of the reading device 11,
   with a first time duration being determined and/or measured as a function of the first point in time and the second point in time. In a step S33, an error detection is performed as a function of the first time duration and the device type and/or software information. This allows specific problems to be detected, which enables countermeasures to be initiated in a particularly favourable manner. In particular, as part of the error detection, the device type and/or software information can be taken into account to determine whether there are errors and/or problems when unbolting the access system 10:
the device type of the mobile device 20; and/or
the version and/or the type of the software application of the mobile device 20; and/or
the version and/or the type of the operating system of the mobile device 20; and/or
a version and/or a type of software of the reading device 11
   and/or the access system 10. For example, problems resulting from a combination of the version and/or the type of the software of the reading device 11 with the version and/or the type of the software application of the mobile device 20 can also be determined and/or assigned in this way.

It is preferably conceivable that the steps of the method are repeated for a number of unbolting attempts and/or for a number of different mobile devices 20, with problems or errors during the unbolting of the access system 10 being identified for:
certain device types of mobile devices; and/or
certain versions and/or types of software application that use mobile devices to unbolt the access system 10; and/or
certain version and/or types of operating systems of mobile devices; and/or
a certain version and/or a certain type of software of the reading device 11 and/or the access system 10

It is conceivable that, as a function of the error detection, in particular as a function of a detected error or problem:
the software application of the mobile device 20 is changed and/or updated; and/or
the operating system of the mobile device 20 is changed and/or updated; and/or
the software of the reading device 11 and/or the access system 10 is changed and/or updated.

Alternatively or additionally, it is conceivable that a message is transmitted from the server system 100 to the mobile device 20 as a function of the error detection, in particular as a function of a detected error or problem,
with the message having information on an error and/or problem detected during the error detection; or
with the message having a request or an instruction:
   to change and/or update the software application of the mobile device 20, and/or
   to change and/or update the operating system of the mobile device 20.
The content of the message is displayed to a user of the mobile device, for example via the playback device 21 of the mobile device 20.

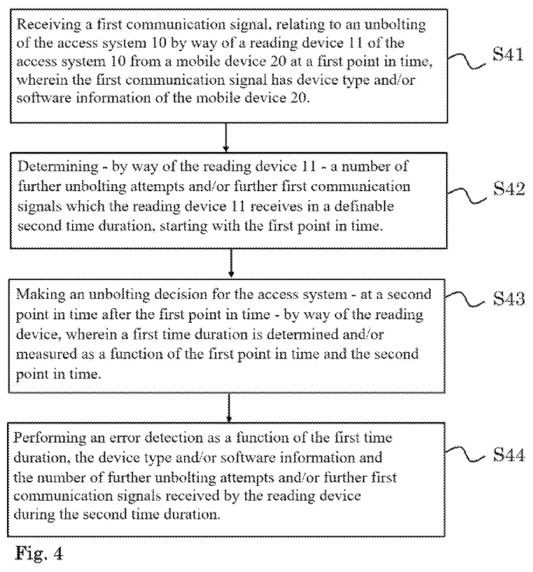

In FIG. 4, a schematic representation of a method for unbolting an access system 10 using a mobile device 20 and/or for error detection, relating to an unbolting of an access system 10, is shown according to an embodiment of the present disclosure. In a step S41, a first communication signal, relating to an unbolting of the access system 10 is received by a reading device 11 of the access system 10 from a mobile device 20 at a first point in time, with the first communication signal having device type and/or software information of the mobile device 20. In a step S42, the reading device 11 determines a number of further unbolting attempts and/or further first communication signals, which the reading device receives in a definable second time duration, starting with the first point in time. Preferably, the determined number relates to
the number of further unbolting attempts and/or further first communication signals which the reading device 11 receives from the mobile device 20 in the definable second time duration, starting with the first point in time, or p1 whether the reading device 11 receives a further unbolting attempt and/or a further first communication signal from the mobile device 20 at all in the second definable time duration, starting with the first point in time. It can therefore be tracked whether further unbolting attempts are made by the mobile device 20 after the first communication signal within the second time duration. This is typically an indication that there were problems with the first unbolting attempt and can therefore enable particularly favourable error detection. In a step S43, an unbolting decision is made for the access system 10—at a second point in time after the first point in time—by way of the reading device 11,
with a first time duration being determined and/or measured as a function of the first point in time and the second point in time. The server system 100 receives information from the reading device 11 and/or the mobile device 20, which indicates:
   the first time duration, and
   the device type and/or software information and
   the number of further unbolting attempts and/or further first communication signals received during the second time duration.
The server system 100 uses this information in step S44. In step S44, an error detection is performed as a function of the first time duration, the device type and/or software information and the number of further unbolting attempts and/or further first communication signals received by the reading device 11 during the second time duration. This enables particularly advantageous error detection.

Features of the exemplary embodiments represented in FIGS. 2, 3 and 4 can be combined with each other.

1. A method for unbolting an access system using a mobile device and/or for error detection, relating to an unbolting of an access system,
wherein the access system has a reading device with a communication interface for receiving communication signals from the mobile device, wherein the method comprises the following steps:
a) Receiving a first communication signal, relating to an unbolting of the access system by way of the reading device from the mobile device at a first point in time, wherein the first communication signal and/or an additional communication signal transmitted from the mobile device to the reading device has device type and/or software information of the mobile device,
b) Making an unbolting decision for the access system at a second point in time after the first point in time—by way of the reading device,
wherein a first time duration between the first point in time and the second point in time is determined and/or measured,
c) Performing an error detection comprising a comparison of the first time duration with one or a plurality of threshold values, wherein it is determined whether errors or problems have occurred during unbolting as a function of the comparison and the device type and/or software information.

2. The method according to claim 1, wherein the method further includes:
wherein the first communication signal has authorisation information for unbolting the access system,
wherein the reading device checks the authorisation information before and/or as part of the unbolting decision,
preferably wherein the unbolting decision in step b) is made taking into account the authorisation information.

3. The method according to claim 1, wherein the device type and/or software information has one of the following items of information:
information indicating a device type of the mobile device; and/or
information indicating a version and/or a type of a software application of the mobile device, wherein the software application is used by the mobile device to unbolt the access system; and/or
information indicating a version and/or a type of an operating system of the mobile device.

4. The method according to claim 1, wherein it is determined as part of the error detection in step c),
whether there are errors and/or problems when unbolting the access system for:
the device type of the mobile device; and/or
the version and/or the type of the software application of the mobile device; and/or
the version and/or the type of the operating system of the mobile device; and/or
a version and/or a type of software of the reading device and/or the access system.

5. The method according to claim 1, wherein the method further includes the following step:
d) Determining—by way of the reading device a number of further unbolting attempts and/or further first communication signals which the reading device receives in a definable second time duration, starting with the first point in time, preferably from the mobile device,
wherein the error detection in step c) is additionally performed taking into account the number of further unbolting attempts and/or further first communication signals received.

6. The method according to claim 1,
wherein the error detection in step c) is performed by a server system,
wherein information is transmitted to the server system before step c) which indicates:
the first time duration, and
optionally the device type and/or software information and
optionally the number of further unbolting attempts and/or further first communication signals received.

7. The method according to claim 1, wherein, as a function of the error detection performed in step c):
the software application of the mobile device is changed and/or updated, wherein the software application is used by the mobile device to unbolt the access system; and/or
the operating system of the mobile device is changed and/or updated; and/or
the software of the reading device and/or the access system is changed and/or updated.

8. The method according to claim 1, wherein a message is transmitted to the mobile device, in particular by the server system, as a function of the error detection performed in step c),
wherein the message has information on an error and/or problem detected during the error detection in step c); or
wherein the message has a request or an instruction:
to change and/or update the software application of the mobile device, and/or
to change and/or update the operating system of the mobile device.

9. The method according to claim 1,
wherein the communication interface of the reading device is designed as an NFC communication interface, a UWB communication interface or a BLE communication interface, wherein the first communication signal is preferably an NFC communication signal, UWB communication signal or BLE communication signal.

10. The method according to claim 1,
wherein a positioning message is transmitted to the mobile device as a function of the error detection in step c), wherein the positioning message has device type-dependent information and/or a request for positioning the mobile device relative to the reading device,
preferably wherein the device type-dependent information and/or request for positioning is communicated to a user via a playback device of the mobile device.

11. A reading device for an access system configured to carry out the method according to claim 1, wherein the reading device has a communication interface for receiving communication signals from a mobile device,
wherein the reading device ( is configured to receive a first communication signal, relating to an unbolting of the access system from the mobile device at a first point in time,
wherein the reading device is configured to make an unbolting decision—at a second point in time after the first point in time,
wherein the reading device is configured to determine and/or measure a first time duration as a function of the first point in time and the second point in time.

12. A system configured to carry out the method according to claim 1, wherein the system comprises an access system with a reading device and a server system,
wherein the reading device has a communication interface for receiving communication signals from a mobile device,
wherein the reading device is configured to receive a first communication signal, relating to an unbolting of the access system from the mobile device at a first point in time,
wherein the reading device is configured to make an unbolting decision—at a second point in time after the first point in time,
wherein the reading device is configured to determine and/or measure a first time duration as a function of the first point in time and the second point in time,
wherein the server system is configured to perform an error detection as a function of the first time duration.

13. A computer program product comprising commands which, when executed by a computer system and/or a reading device and/or a server system, cause it to carry out the method according to claim 1.
